(19) United States
(12) Patent Application Publication
(10) Pub. No.: US 2026/0247211 A1
(43) Pub. Date: Aug. 20, 2026

(54) METHOD AND APPARATUS FOR HANDLING EXTENDED REALITY TRAFFIC IN A WIRELESS NETWORK SYSTEM

(71) Applicant: Samsung Electronics Co., Ltd., Suwon-si, Gyeonggi-do (KR)

(72) Inventors: Sriganesh RAJENDRAN, Bangalore (IN); Aby Kanneath ABRAHAM, Bangalore (IN); Vinay Kumar SHRIVASTAVA, Bangalore (IN)

(21) Appl. No.: 19/156,326

(22) PCT Filed: Feb. 16, 2024
(86) PCT No.: PCT/KR2024/095328

§ 371 Date: Aug. 13, 2025

(30) Foreign Application Priority Data
Feb. 17, 2023 (KR) 202341010732
Feb. 2, 2024 (KR) 202341010732

(51) Int. Cl. H04W 28/06; H04W 28/02; H04W 80/02

(52) U.S. Cl. CPC H04W 28/06; H04W 28/0278; H04W 80/02

(57) ABSTRACT

The disclosure relates to a 5G or 6G communication system for supporting a higher data transmission rate. Embodiments herein disclose a UE (101) for handling XR traffic in a wireless network. An XR traffic controller (106) receives a PDCP SDU from an upper layer of the UE (101). The XR traffic controller (106) checks for the configuration of a first discard timer for low-importance PDCP SDUs and the activation of PSI-based SDU discard. The XR traffic controller (106) then identifies whether the received PDCP SDU belongs to a low-importance PDU set. Subsequently, it initiates the first discard timer for the associated low-importance PDCP SDU. If the discard timer for the low-importance PDU set is configured and PSI-based SDU discard is active, the XR traffic controller (106) checks if the first discard timer or the second discard timer has expired for the received PDCP SDU. Based on the conditions, it either discards all PDCP SDUs along with corresponding PDCP data PDUs belonging to the low-importance PDU set or selectively discards only the corresponding PDCP data SDUs, depending on the configuration of the PDU set discard at the UE (101).

### TECHNICAL FIELD

The present disclosure relates to wireless communication networks. More particularly, it relates to a terminal and a method for handling extended reality (XR) traffic in a wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Extended Reality (XR) is a comprehensive term that encompasses various realities, including Virtual Reality (VR), Augmented Reality (AR), and Mixed Reality (MR). It is regarded as a crucial technology in realizing the digital twin/meta-universe concept. Notably, XR has been formally incorporated as a planned task in the Fifth-generation (5G) Advanced, specifically in 3GPP Release 18. This release seeks to establish a communication system framework that can meet the demanding requirements of high data rates, ultra-low latency, and power-efficient connectivity necessary for XR applications.

In the realm of XR applications, the conventional approach of linking Protocol Data Units (PDUs) to Data Radio Bearers/Logical Channels (DRBs/LCHs) solely through a Quality of Service (QoS) Flow Identifier (QFI) value may prove to be less dependable. This is due to the fact that XR applications frequently comprise packets of varying degrees of significance, all within a single QoS Flow. Such a method can lead to issues such as ineffective scheduling or discarding of packets, ultimately resulting in a suboptimal user experience.

The System Architecture and Services (SA2) workgroup of the Third Generation Partnership Project (3GPP) has endeavored to enhance the system by introducing the concept of PDU sets. These sets comprise one or more PDUs that convey crucial information generated at the application level, such as a frame or a slice of video for XRM services. In certain instances, all the PDUs in a PDU set are indispensable for the application layer to utilize the corresponding piece of information. However, in other cases, even if certain PDUs are missing, the application layer can still assemble parts or the entirety of the information unit.

In the realm of XR services, the RAN node assumes responsibility for upholding Quality of Service (QoS) standards in accordance with the QoS parameters of the PDU sets.

It is desired to address the above-mentioned disadvantages or other shortcomings or at least provide a useful alternative.

### DISCLOSURE OF INVENTION

### Technical Problem

The principal object of the embodiments herein is to disclose a terminal and a method for handling extended reality (XR) traffic in a wireless network.

Yet another object of the embodiments herein is to accept a PDCP SDU from an upper layer of the UE which is part of the XR traffic.

Another object of the embodiments herein is to determine the configuration of a discard timer for low-priority Service Data Units (SDUs) and the activation of a Protocol Data Unit (PDU) set importance information (PSI) based SDU discard by the UE.

Another object of the embodiments herein is to determine whether the received PDCP SDU belongs to a low importance PDU set. The determination is based on the configuration of the discard timer for the low importance PDU and the PSI-based SDU discard activation/deactivation.

Another object of the embodiments herein is to determine whether a PDU set discard is configured at the UE when the first discard timer for the low importance or a second discard timer is expired for the received PDCP SDU.

Another object of the embodiments herein is to discard all PDCP SDUs belonging to the low importance PDU set to which the received PDCP SDU belongs along with the corresponding PDCP data SDUs. The discard takes place when the PDU set discard is configured at the UE and the first discard timer for the low importance is expired for the received PDCP SDU.

Another object of the embodiments herein is to discard all PDCP SDUs belonging to the PDU set to which the received PDCP SDU belongs along with the corresponding PDCP data SDUs. The discard takes place when the PDU set discard is configured at the UE and the second discard timer is expired for the received PDCP SDU.

Another object of the embodiments herein is to discard only the corresponding PDCP data SDUs when the first discard timer for the low importance or the second discard timer is expired and the PDU set discard is not configured at the UE.

Another object of the embodiments herein is to receive a PSI-based SDU discard medium access control (MAC) control element (CE) for activation and deactivation of the PSI-based SDU discard by the UE.

Another object of the embodiments herein is to indicate to the upper layer to activate or deactivate the PSI-based SDU discard for the DRB, when the PSI-based SDU discard MAC CE is received for activation.

### Solution to Problem

Accordingly, an embodiment herein provides a user equipment (UE) for handling an extended reality (XR) traffic in a wireless network. The UE includes a processor and an XR traffic controller coupled to the processor. The XR traffic controller receives a PDCP SDU from an upper layer of the UE. Further, the XR traffic controller determines whether a first discard timer for a low importance SDU is configured and a PDU set importance information (PSI) based SDU discard is activated. The XR traffic controller further determines whether the received PDCP SDU belongs to a low importance PDU. The XR traffic controller then starts the first discard timer for low importance associated with the received PDCP SDU. When the discard timer for the low importance PDU set is configured and the PSI-based SDU discard is activated, the received PDCP SDU belongs to the low importance PDU set. Further, the XR traffic controller starts a second discard timer associated with the received PDCP SDU. When at least one of the discard timers for the low importance PDU set is not configured and the PSI-based SDU discard is deactivated, the received PDCP SDU does not belong to the low importance PDU set.

In an embodiment, the XR traffic controller of the UE determines whether the first discard timer for the low importance or the second discard timer is expired for the received PDCP SDU. The XR traffic controller further determines whether a PDU set discard is configured at the UE. The XR traffic controller then discards all PDCP SDUs belonging to the low importance PDU set to which the received PDCP SDU belongs along with the corresponding PDCP data PDUs. This discard takes place when the first discard timer for the low importance is expired and the PDU set discard is configured at the UE. The XR traffic controller discards all PDCP SDUs belonging to a PDU set to which the received PDCP SDU belongs along with the corresponding PDCP data PDUs. This discard takes place when the second discard timer is expired and the PDU set discard is configured at the UE. The XR traffic controller may discard only the corresponding PDCP data SDUs. This discard happens when the first discard timer for the low importance is expired and the PDU set discard is not configured at the UE. Further, the XR traffic controller may discard only the corresponding PDCP data SDUs, when the second discard timer is expired and the PDU set discard is not configured at the UE.

In an embodiment, the UE receives the discard timer for low importance from a network apparatus. The discard timer is configured only for data radio bearers (DRBs). The duration of the discard timer is configured by the upper layer of the UE.

In an embodiment, the UE starts a low importance discard timer upon receiving the PDU SDU belonging to a low importance PDU set from the upper layer of the UE.

In an embodiment, the XR traffic controller of the UE receives a PSI-based SDU discard MAC CE for activation and deactivation of the PSI-based SDU discard. The UE indicates the activation of the PSI-based SDU discard for the DRB to the upper layer. The UE then activates the PSI-based SDU discard for the DRB, when the PSI-based SDU discard MAC CE is received for activation. Further, the UE indicates the deactivation of the PSI-based SDU discard for the DRB to the upper layer. The UE then deactivates the PSI-based SDU discard for the DRB, when the PSI-based SDU discard MAC CE is received for deactivation.

In an embodiment, the method includes handling extended reality (XR) traffic in the wireless network. The method includes receiving the PDCP SDU from an upper layer of the UE. The UE determines whether the first discard timer for low importance SDU is configured and the PSI-based SDU discard is activated. The UE further determines whether the received PDCP SDU belongs to a low importance PDU set. For determination, the UE starts the first discard timer for low importance associated with the received PDCP SDU. When the discard timer for the low importance PDU set is configured, the PSI-based SDU discard is activated, and the received PDCP SDU belongs to the low importance PDU set. Further, the UE starts a second discard timer associated with the received PDCP SDU. When at least one of the discard timers for the low importance PDU set is not configured, the PSI-based SDU discard is de-activated, and the received PDCP SDU does not belong to the low importance PDU set.

In an embodiment, the method includes determining whether the first discard timer for the low importance or the second discard timer is expired for the received PDCP SDU. Based on this, the method further determines whether the PDU set discard is configured at the UE. The UE discards all PDCP SDUs belonging to the low importance PDU set to which the received PDCP SDU belongs along with corresponding PDCP data SDUs. The discard takes place when the PDU set discard is configured at the UE and the first discard timer for the low importance is expired for the received PDCP SDU. The UE further discards all PDCP SDUs belonging to a PDU set to which the received PDCP SDU belongs along with corresponding PDCP data SDUs. The discard takes place when the PDU set discard is configured at the UE and the second discard timer is expired for the received PDCP SDU. The UE may also discard only the corresponding PDCP data SDUs. The discard happens when the first discard timer for the low importance or the second discard timer is expired and the PDU set discard is not configured at the UE.

In an embodiment, the method includes receiving the PSI-based SDU discard MAC CE for activation and deactivation of the PSI-based SDU discard. The method further includes the UE to indicate to the upper layer to activate or deactivate the PSI-based SDU discard for the DRB, when the PSI-based SDU discard MAC CE is received for activation.

These and other aspects of the embodiments herein will be better appreciated and understood when considered in conjunction with the following description and the ac-companying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

According to an embodiment of present disclosure, a terminal can efficiently perform a communication.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a block diagram of a User Equipment (UE) for handling an extended reality (XR) traffic in a wireless network, according to the embodiment disclosed herein;

FIG. 2 illustrates a flowchart related to a method for determination of the low importance PDU set, according to the embodiment disclosed herein;

FIG. 3 illustrates a flowchart related to a method for discarding PDCP SDUs belonging to the low importance PDU set and corresponding PDCP data SDUs, according to the embodiment disclosed herein;

FIG. 4 illustrates a flowchart related to a method for activating or deactivating the PSI-based SDU discard for the DRB, according to the embodiment disclosed herein;

FIG. 5 illustrates a flowchart related to a method for performing congestion-based discard operation at a PDCP layer for XR services, according to the embodiment disclosed herein;

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help improve the understanding of aspects of the invention. Furthermore, the elements may have been represented in the drawing by conventional symbols, and the drawings may show only those specific details that are pertinent to the understanding of the embodiments of the invention so as not to obscure the drawing with details that will be readily apparent to those of ordinary skill in the art having the benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments are described and illustrated in terms of blocks that carry out a described function or functions. These blocks, which are referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Embodiments disclosed herein provide a method for configuring and operating User Equipment's (UEs) for handling an Extended Reality (XR) traffic in a wireless network. In the proposed method, the System Architecture and Services (SA2) work group has concluded that multiple Protocol Data Unit (PDU) sets with varying im-portance can be mapped to a single Quality of Service (QoS) flow. The PDU set im-portance information is conveyed to a Radio Access Network (RAN) Node through an indication as part of General Packet Radio Services (GPRS) Tunnelling Protocol (GTP)-U header and a User Plane Function (UPF) performs an action of marking the packets with appropriate importance information value. The proposed invention describes the way to make use of the importance information in the RAN node to perform PDU set based QoS handling.

Embodiments disclosed herein provide the UE for handling the XR traffic in the wireless network. The UE includes a processor and an XR traffic controller coupled to the processor. The XR traffic controller receives a PDCP SDU from an upper layer of the UE. Further, the XR traffic controller determines whether a first discard timer for a low importance SDU is configured and a PDU set importance information (PSI) based SDU discard is activated. The XR traffic controller further determines whether the received PDCP SDU belongs to a low importance PDU. The XR traffic controller then starts the first discard timer for low importance associated with the received PDCP SDU. When the discard timer for the low importance PDU set is configured and the PSI-based SDU discard is activated, the received PDCP SDU belongs to the low importance PDU set. Further, the XR traffic controller starts a second discard timer associated with the received PDCP SDU. When at least one of the discard timers for the low importance PDU set is not configured and the PSI-based SDU discard is de-activated, the received PDCP SDU does not belong to the low importance PDU set.

Embodiments disclosed herein provide the XR traffic controller. The XR traffic controller determines whether the first discard timer for the low importance or the second discard timer is expired for the received PDCP SDU. The XR traffic controller further determines whether a PDU set discard is configured at the UE. The XR traffic controller then discards all PDCP SDUs belonging to the low importance PDU set to which the received PDCP SDU belongs along with the corresponding PDCP data PDUs. This discard takes place when the first discard timer for the low importance is expired and the PDU set discard is configured at the UE. The XR traffic controller discards all PDCP SDUs belonging to a PDU set to which the received PDCP SDU belongs along with the corresponding PDCP data PDUs. This discard takes place when the second discard timer is expired and the PDU set discard is configured at the UE. The XR traffic controller may discard only the corresponding PDCP data SDUs. This discard happens when the first discard timer for the low importance is expired and the PDU set discard is not configured at the UE. Further, the XR traffic controller may discard only the corresponding PDCP data SDUs, when the second discard timer is expired and the PDU set discard is not configured at the UE.

Embodiments disclosed herein provide a method that includes handling extended reality (XR) traffic in the wireless network. The method includes receiving the PDCP SDU from an upper layer of the UE. The UE determines whether the first discard timer for low importance SDU is configured and the PSI-based SDU discard is activated. The UE further determines whether the received PDCP SDU belongs to a low importance PDU set. For determination, the UE starts the first discard timer for low importance associated with the received PDCP SDU. When the discard timer for the low importance PDU set is configured, the PSI-based SDU discard is activated, and the received PDCP SDU belongs to the low importance PDU set. Further, the UE starts a second discard timer associated with the received PDCP SDU. When at least one of the discard timers for the low importance PDU set is not configured, the PSI-based SDU discard is deactivated, and the received PDCP SDU does not belong to the low importance PDU set.

Embodiments disclosed herein provide the method for determining whether the first discard timer for the low importance or the second discard timer is expired for the received PDCP SDU. Based on this, the method further determines whether the PDU set discard is configured at the UE. The UE discards all PDCP SDUs belonging to the low importance PDU set to which the received PDCP SDU belongs along with corresponding PDCP data SDUs. The discard takes place when the PDU set discard is configured at the UE and the first discard timer for the low importance is expired for the received PDCP SDU. The UE further discards all PDCP SDUs belonging to a PDU set to which the received PDCP SDU belongs along with corresponding PDCP data SDUs. The discard takes place when the PDU set discard is configured at the UE and the second discard timer is expired for the received PDCP SDU. The UE may also discard only the corresponding PDCP data SDUs. The discard happens when the first discard timer for the low importance or the second discard timer is expired and the PDU set discard is not configured at the UE.

The UE aims to enhance the protocol stack to handle XR traffic by introducing XR specific awareness to the wireless network. The XR traffic is characterized by a high data rate and lower latency. Another characteristic feature of the XR traffic is that not all packets are of equal importance, whereas in the receiver can still recover/maintain the quality when lower importance packets are not received successfully.

To address this, especially during the case of traffic/congestion, the XR traffic controller receives a PDCP SDU from an upper layer of the UE and determines whether the received PDCP SDU belongs to the low importance PDU or not. The XR traffic controller then discards the packets of lower importance to ensure packets of higher importance get delivered. There is a gap in existing specification to implement this selective discard mechanism at PDCP.

The proposed technical solution boasts inventive features that involve the implementation of a procedure for receiving the PDCP SDU from the upper layer of the UE and determining whether the received PDCP SDU belongs to the low importance PDU or not. The XR traffic controller then discards all the PDCP SDUs belonging to the low importance PDU set, discards all the PDCP SDUs belonging to the PDU set to which the received PDCP SDU belongs or discards only the corresponding PDCP data SDUs. The discard happens based on the first discard timer for the low importance or the second discard timer and the PDU set discard configuration at the UE.

This inventive feature, which is disclosed herein, efficiently manages the prioritization for satisfying QoS requirements for XR traffic. This helps for proactive PDCP discard during traffic/congestion in the wireless network.

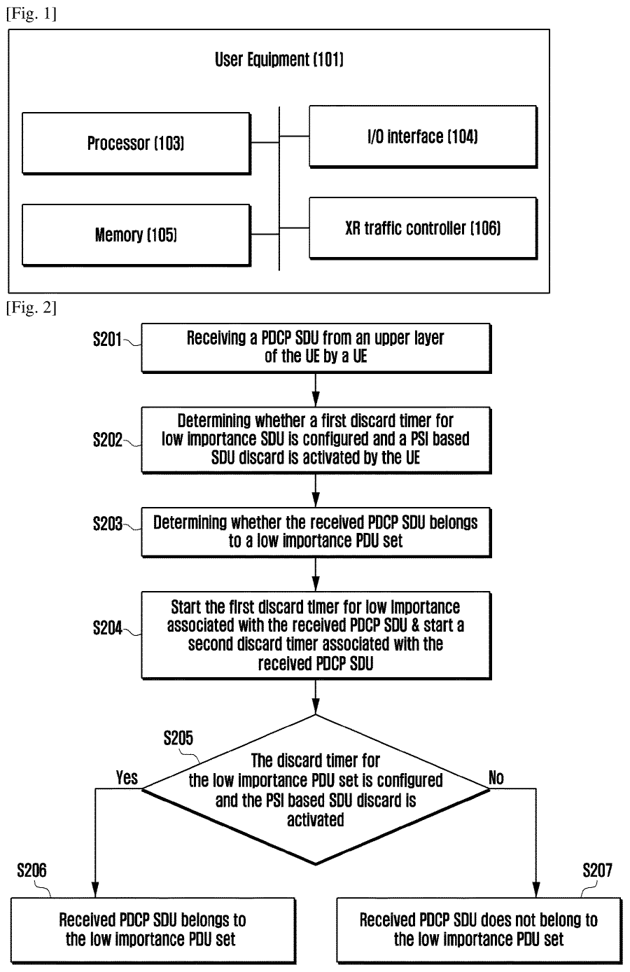

Embodiments herein achieve UE and a method for handling XR traffic in a wireless network. Referring now to the drawings, and more particularly to FIGS. 1 through 5, where similar reference characters denote corresponding features consistently throughout the figures, there are shown embodiments.

FIG. 1 illustrates a block diagram of the UE (101) (e.g., terminal) for handling the XR traffic in the wireless network. The UE (201) may include a processor (103), an input/output (I/O) interface (104), a memory (105) and the XR traffic controller (106) coupled to the processor (103).

The processor (103) is configured to execute instructions stored in the memory (105) and to perform various processes. The processor (103) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (105) of the UE (101) includes storage locations to be addressable through the processor (103). The memory (105) is not limited to a volatile memory (103) and/or a non-volatile memory (205). Further, the memory (105) can include one or more computer-readable storage media. The memory (105) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (105) stores the PDCP SDUs received from the upper layer of the UE. The memory (105) further stores the first discard timer for a low importance SDU and a second discard timer. The memory (105) also stores the discard timer for low importance received from the network apparatus. In some embodiment, the memory (105) stores information regarding the determined categories of the received PDCP SDUs such as low importance PDU set, high importance PDU set.

The I/O interface (104) transmits the information between the memory (105) and external peripheral devices. The peripheral devices are the input-output devices associated with the UE (101). The I/O interface (104) receives information from the upper layer of the UE (101). The information can include but is not limited to PDCP SDUs received from the upper layer of the UE (101), the discard timer for low im-portance received from the network apparatus and other XR traffic related signals.

The XR traffic controller (106) is an innovative hardware that is realized through the physical implementation of both analog and digital circuits, including logic gates, integrated circuits, microprocessors, microcontrollers, memory circuits, passive and active electronic components, as well as optical components.

In an embodiment, the XR traffic controller (106) of the UE (101) communicates with the communication processor (103), the I/O interface (104) and the memory (105) to receive information regarding the PDCP SDUs from the upper layer of the UE (101) and the discard timer for low importance received from the network apparatus.

Further, the XR traffic controller (106) receives the PDCP SDU from the upper layer of the UE (101). The XR traffic controller (106) determines the importance level of the received PDCP SDUs and discards them based on the first discard timer expiration for the low importance, the second discard timer expiration for the high importance and the PDU set discard configuration at the UE (101).

After receiving the PDCP SDUs, the XR traffic controller (106) determines whether the first discard timer for the low importance SDU is configured and the PSI-based SDU discard is activated. The XR traffic controller (106) further determines whether the received PDCP SDU belongs to a low importance PDU. The XR traffic controller starts the first discard timer for low importance associated with the received PDCP SDU. The received PDCP SDU is determined as the low importance PDU set when the discard timer for the low importance PDU set is configured and the PSI-based SDU discard is activated.

Further, the XR traffic controller (106) starts the second discard timer associated with the received PDCP SDU. The received PDCP SDU is determined as not being the low importance PDU set when at least one of the discard timers for the low importance PDU set is not configured and the PSI-based SDU discard is deactivated. Once the im-portance level of the received PDCP SDUs is determined, the XR traffic controller (106) further tracks the expiry timings for the first discard timer and the second discard timer.

In an embodiment, the XR traffic controller (106) of the UE (101) determines whether the first discard timer for the low importance or the second discard timer is expired for the received PDCP SDU. The XR traffic controller (106) further determines, whether the PDU set discard is configured at the UE. The XR traffic controller discards all the PDCP SDUs belonging to the low importance PDU set to which the received PDCP SDU belongs. The discard also includes the corresponding PDCP data PDUs. This discard takes place when the first discard timer for the low im-portance is expired and the PDU set discard is configured at the UE (101).

Further, the XR traffic controller (106) discards all the PDCP SDUs belonging to the PDU set to which the received PDCP SDU belongs. The discard here also includes the corresponding PDCP data PDUs. This discard takes place when the second discard timer is expired and the PDU set discard is configured at the UE (101).

The XR traffic controller (106), discards only the corresponding PDCP data SDUs. This discard happens when the first discard timer for the low importance is expired and the PDU set discard is not configured at the UE (101). The XR traffic controller (106) may also discard only the corresponding PDCP data SDUs when the second discard timer is expired and the PDU set discard is not configured at the UE (101).

In an embodiment, the UE (101) receives the discard timer for low importance from the network apparatus. This discard timer is configured only for data radio bearers (DRBs).

In an embodiment, the duration of the discard timer is configured by the upper layer of the UE (101).

In an embodiment, all PDU sets with the same importance level are treated uniformly within the DRB and/or LCH in which they are mapped to.

In an embodiment, a new PDCP discard functionality is introduced to proactively discard PDUs from PDU sets with lower importance level.

In an embodiment, the PDU set importance level below which the PDU sets are discarded to mitigate congestion is configured by the network.

In an embodiment, a discard function can be configured to discard all the packets from the PDU set or perform partial discard of the PDU set based on the PDU Set integrated handling information and/or congestion level.

In an embodiment, a PDCP layer maps PDU sets with different importance level to the same DRB and/or LCH.

In an embodiment, the UE (101) starts the low importance discard timer upon receiving the PDU SDU belonging to the low importance PDU set from the upper layer of the UE (101).

In an embodiment, the XR traffic controller (106) of the UE (101) receives a PSI-based SDU discard MAC CE for activation and deactivation of the PSI-based SDU discard. The UE (101) indicates the activation of the PSI-based SDU discard for the DRB to the upper layer. The UE (101) then activates the PSI-based SDU discard for the DRB, when the PSI-based SDU discard MAC CE is received for activation. Further, the UE (101) indicates the deactivation of the PSI-based SDU discard for the DRB to the upper layer. The UE (101) then deactivates the PSI-based SDU discard for the DRB, when the PSI-based SDU discard MAC CE is received for deactivation.

In an embodiment, in order to perform prioritization based on the PDU set importance, a Service Data Adaptation Protocol (SDAP) layer conveys the importance information as part of its header to lower layer. In an embodiment, the transmitter side of a Packet Data Convergence Protocol (PDCP) layer at a gNB is configured to perform mapping of downlink PDUs belonging to a PDU set to a logical channel based on the PDU Set importance information conveyed as part of the GTP-U header or pre-configured as part of the PDU set configuration and maps based on the PDU set Identity.

In an embodiment, a transmitter entity of the PDCP layer in the UE performs the mapping of uplink PDUs belonging to a PDU set to a logical channel following the mapping rules received from the network. The mapping is done based on the importance information provided to the UE Access Stratum through a data plane and/or an application layer.

In an embodiment, the PSI-based discard can be performed by configuring different discard timers for PDUs part of PDU sets having different importance information.

The discard timer PDU sets with lower importance can be configured with smaller discard timer values and PDU sets with higher importance can be configured with longer discard values so that the chances of discard for higher importance PDU sets are less.

In an embodiment, a new congestion discard timer is introduced in PDCP which is started when RAN node detects congestion and/or is indicated from the UPF and/or UE about the congestion. The PDCP initiates proactive PDU set discard procedure when the congestion discard timer expires. The PDCP layer stops and/or resets the congestion timer when PDCP is indicated that change there is alleviation in the congestion status.

In an embodiment, the PDCP layer is configured with the minimum number of PDU sets to discard when the congestion/traffic-based discard procedure is initiated due to an indication regarding the congestion.

In an embodiment, the PDCP layer performs duplication of packets based on the importance information. The PDCP is configured to apply duplication for PDCP SDUs having higher importance levels. The duplication achieves more reliability for PDCP SDUs with higher importance as it immediately compensates for loss of any PDCP SDU during the transmission.

In an embodiment, the PDCP SDUs with higher importance can be prioritized for transmission by employing a priority-based queue for the PDCP buffer instead of a First-In-First-Out buffer.

In an embodiment, the PDCP layer maintains separate buffers or queues for PDCP SDUs with different importance levels. The SDAP pushes the PDCP SDUs to the different buffers according to the importance information. The PDCP layer processes the SDUs from buffer holding PDU sets with higher importance levels thus enabling PDU set prioritization at the RAN level.

In an embodiment, the PDCP layer is configured to perform priority based SDU buffer when out of order delivery is enabled by the application.

In an embodiment, in case of an uplink traffic, when the PDCP layer is configured to map the PDCP SDUs with different importance information into logical channel of the same Logical Channel Group (LCH), the MAC layer can be configured to report the importance information along with the Buffer size information in buffer status report (BSR).

In an embodiment, a new BSR for XR is introduced to carry the Buffer size information per importance level. Alternatively, the percentage of size of PDCP SDUs in each of the importance levels can be indicated along with the total buffer size in the BSR.

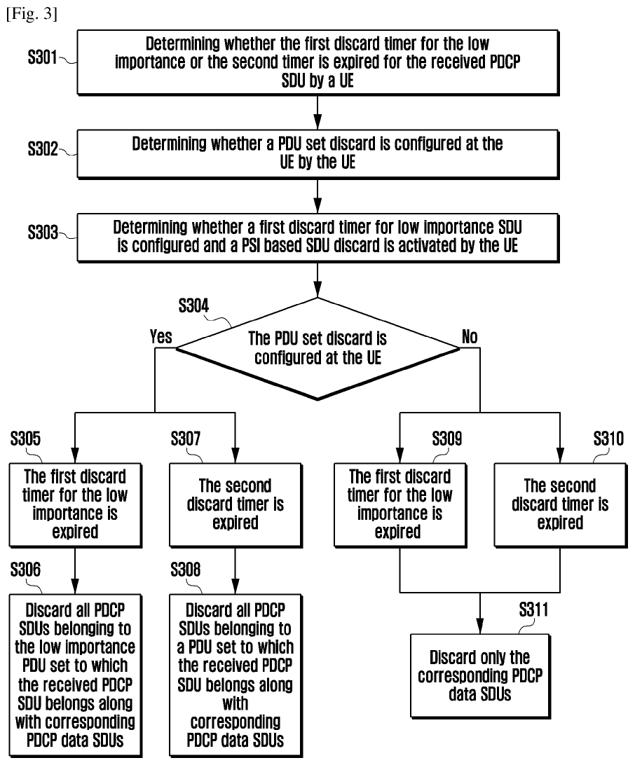

FIG. 2 illustrates a flowchart related to a method for determination of the low im-portance PDU set among the received PDCP SDU sets from the upper layer of the UE. At step S201, the UE may receive the PDCP SDU from an upper layer of the UE. According to one embodiment, the PDCP SDU is delivered from the upper layer to a PDCP layer of the UE.

At step S202, the UE may determine whether a first discard timer for low importance SDU is configured and the PSI-based SDU discard is activated.

At step S203, the UE may determine whether the received PDCP SDU belongs to a low importance PDU set.

At step S204, the UE may start the first discard timer for low importance associated with the received PDCP SDU and starts a second discard timer associated with the received PDCP SDU.

At step S205, the decision may be taken whether the discard timer for the low im-portance PDU set is configured and the PSI-based SDU discard is activated.

At step S206, the received PDCP SDU may be determined as the low importance PDU set when the discard timer for the low importance PDU set is configured and the PSI-based SDU discard is activated.

At step S207, the received PDCP SDU may be determined as not being the low im-portance PDU set when at least one of the discard timers for the low importance PDU set is not configured and the PSI-based SDU discard is deactivated. Once the im-portance level of the received PDCP SDUs is determined, the XR traffic controller further tracks the expiry timings for the first discard timer and the second discard timer.

FIG. 3 illustrates the flowchart related to the method for discarding the PDCP SDUs belonging to the low importance PDU set and corresponding PDCP data SDUs. The discard happens based on the first discard timer for the low importance or the second discard timer and the PDU set discard configuration at the UE.

At step S301, the UE may determine whether the first discard timer for the low im-portance or the second timer is expired for the received PDCP SDU.

At step S302, the UE may determine whether the PDU set discard is configured at the UE.

At step S303, the UE may further determine whether a first discard timer for low im-portance SDU is configured and the PSI-based SDU discard is activated by the UE.

At step S304, the decision may be taken whether the PDU set discard is configured at the UE or not.

At step S305, when the first discard timer for the low importance may be expired and the PDU set discard is configured at the UE, then

At step S306, the UE may discard all PDCP SDUs belonging to the low importance PDU set to which the received PDCP SDU belongs. The UE may also discard corresponding PDCP data SDUs.

At step S307, when the second discard timer is expired and the PDU set discard is configured at the UE, then

At step S308, the UE may discard all PDCP SDUs belonging to the PDU set to which the received PDCP SDU belongs. The UE also discards corresponding PDCP data SDUs.

At step S309, when the first discard timer for the low importance is expired and the PDU set discard is not configured at the UE, and

At step S310, when the second discard timer is expired and the PDU set discard is not configured at the UE, then

At step S311, the UE may discard only the corresponding PDCP data SDUs.

In an embodiment, the UE receives the discard timer for low importance from the network apparatus. This discard timer is configured only for data radio bearers (DRBs).

In an embodiment, the duration of the discard timer is configured by the upper layer of the UE.

In an embodiment, all the PDU sets with the same importance level are treated uniformly within the DRB and/or LCH to which they are mapped.

In an embodiment, a new PDCP discard functionality is introduced to proactively discard PDUs from PDU sets with lower importance level.

In an embodiment, the PDU set importance level below which the PDU sets are discarded to mitigate congestion is configured by the network.

In an embodiment, a discard function can be configured to discard all the packets from the PDU set or perform partial discard of the PDU set based on the PDU Set integrated handling information and/or congestion level.

In an embodiment, the PDCP layer maps PDU sets with different importance levels to the same DRB and/or LCH.

In an embodiment, the UE starts the low importance discard timer upon receiving the PDU SDU belonging to the low importance PDU set from the upper layer of the UE.

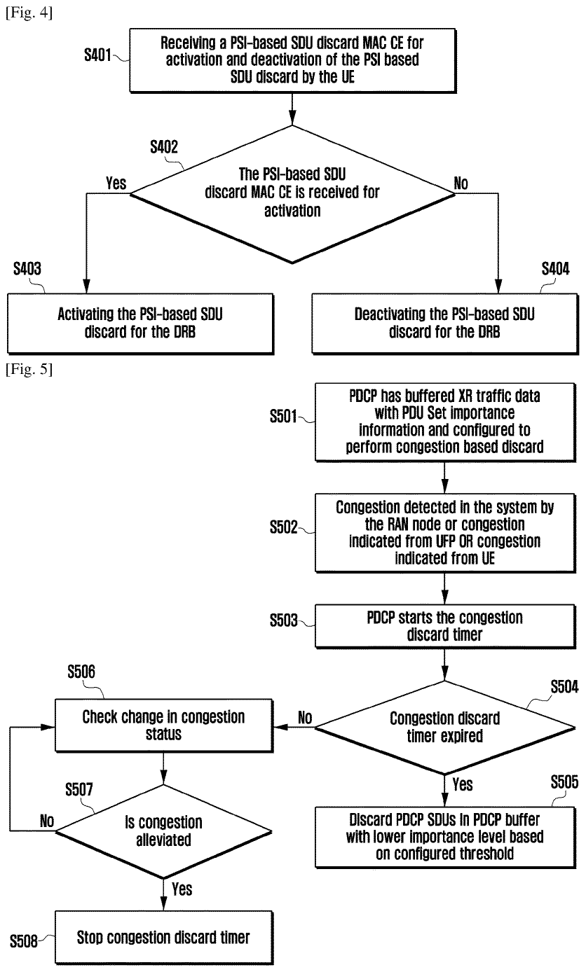

FIG. 4 illustrates a flowchart related to a method for activating or deactivating the PSI-based SDU discard for the DRB.

At step S401, the UE may receive the PSI-based SDU discard MAC CE for activation and deactivation of the PSI-based SDU discard.

At step S402, the decision may be taken whether the PSI-based SDU discard MAC CE is received for activation or not.

At step S403, the UE may indicate the upper layer to activate the PSI-based SDU discard for the DRB. The indication may be sent when the PSI-based SDU discard MAC CE is received for activation.

At step S404, the UE may indicate the upper layer to deactivate the PSI-based SDU discard for the DRB. The indication may be sent when the PSI-based SDU discard MAC CE is received for deactivation.

In an embodiment, FIG. 5 illustrates a flowchart related to a method for performing congestion-based discard operation at a PDCP layer for XR services. At step S501, the PDCP has buffered XR traffic data with PDU set importance information and configured to perform congestion-based discard

At step S502, the congestion may be detected in the system by the RAN node or congestion indicated from the UFP OR the UE.

At step S503, the PDCP may start the congestion discard timer once the congestion is detected in the system.

At step S504, a decision may be taken whether the congestion discard timer is expired or not.

At step S505, the PDCP SDUs in PDCP buffer with lower importance level may be discarded based on configured threshold. This discard may take place when the congestion discard timer is expired.

At step S506, congestion status check may be performed if the congestion discard timer is not expired.

At step S507, a decision may be taken whether the congestion is alleviated or not.

At step S508, the congestion discard timer may be stopped if the congestion is alleviated. Further, if the congestion is not alleviated, congestion status check is performed again.

In an embodiment, the PSI-based discard can be performed by configuring different discard timers for PDUs part of PDU sets having different importance information. The discard timer PDU sets with lower importance can be configured with smaller discard timer values and PDU sets with higher importance can be configured with longer discard values so that the chances of discard for higher importance PDU sets are less.

In an embodiment, a new congestion discard timer is introduced in PDCP which is started when RAN node detects congestion and/or is indicated from the UPF and/or UE about the congestion. The PDCP initiates proactive PDU set discard procedure when the congestion discard timer expires. The PDCP layer stops and/or resets the congestion timer when PDCP is indicated that change there is alleviation in the congestion status.

In an embodiment, the PDCP layer is configured with the minimum number of PDU sets to discard when the congestion/traffic-based discard procedure is initiated due to an indication regarding the congestion.

In an embodiment, the PDCP layer performs duplication of packets based on the im-portance information. The PDCP is configured to apply duplication for PDCP SDUs having higher importance levels. The duplication achieves more reliability for PDCP SDUs with higher importance as it immediately compensates for the loss of any PDCP SDU during the transmission.

In an embodiment, the PDCP SDUs with higher importance can be prioritized for transmission by employing a priority-based queue for the PDCP buffer instead of a First-In-First-Out buffer.

In an embodiment, the PDCP layer maintains separate buffers or queues for PDCP SDUs with different importance levels. The SDAP pushes the PDCP SDUs to the different buffers according to the importance information. The PDCP layer processes the SDUs from buffer holding PDU sets with higher importance levels thus enabling PDU set prioritization at the RAN level.

In another embodiment, the PDCP layer is configured to perform priority based SDU buffer when out of order delivery is enabled by the application.

In an embodiment, in case of an uplink traffic, when the PDCP layer is configured to map the PDCP SDUs with different importance information into logical channel of the same Logical Channel Group (LCH), the MAC layer can be configured to report the importance information along with the Buffer size information in buffer status report (BSR).

In an embodiment, a new BSR for XR is introduced to carry the Buffer size information per importance level. Alternatively, the percentage of size of PDCP SDUs in each of the importance levels can be indicated along with the total buffer size in the BSR.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a terminal in a wireless communication system, the method comprising:
identifying whether a discard timer for low importance is configured;
identifying whether a protocol data unit (PDU) set importance information (PSI) based service data unit (SDU) discard is activated;
identifying whether a PDCP SDU is delivered from an upper layer belongs to a low importance PDU set; and
in case that the discard timer for low importance is configured, the PSI base SDU discard is activated, and the PDCP SDU is delivered from the upper layer belongs to the low importance PDU set, starting the discard timer for low importance associated with the PDCP SDU.

2. The method of claim 1, further comprising:
identifying that the discard timer for low importance is expired for the PDCP SDU;
identifying whether a PDU set discard is configured; and
discarding at least one PDCP SDU belongs to a PDU set, in case that the PDU set discard is configured.

3. The method of claim 2, wherein one or more PDCP SDUs subsequently received from the upper layer are discarded, in case that the one or more PDCP SDUs belongs to the PDU set.

4. The method of claim 1, further comprising:
receiving a medium access control (MAC) control element (CE) indicating an activation or a deactivation of the PSI based SDU discard for at least one data radio bearer (DRB),
wherein the PSI based SDU discard is activated, in case that the received MAC CE indicates the activation for the PSI based SDU discard.

5. The method of claim 4, wherein the PSI based SDU discard is de-activated, in case that the received MAC CE indicates the deactivation for the PSI based SDU discard.

6. A method performed by a base station in a wireless communication system, the method comprising:
transmitting, to a terminal, a control message including information on a discard timer for low importance; and
transmitting, to the terminal, a medium access control (MAC) control element (CE) indicating an activation or a deactivation of the PSI based SDU discard for at least one data radio bearer (DRB),
wherein, in case that the discard timer for low importance is configured, the PSI base SDU discard is activated, and a PDCP SDU is identified to belongs to a low importance PDU set, by the terminal, the discard timer for low importance is started associated with the PDCP SDU.

7. The method of claim 6,
wherein the control message further includes information on a PDU set discard, and
wherein at least one PDCP SDU belongs to a PDU set is discarded, by the terminal, based on the information on the PDU set discard.

8. A terminal in a wireless communication system, the method comprising:
a transceiver; and
at least one processor is configured to:
identify whether a discard timer for low importance is configured, identify whether a protocol data unit (PDU) set importance information (PSI) based service data unit (SDU) discard is activated,
identify whether a PDCP SDU is delivered from an upper layer belongs to a low importance PDU set, and
in case that the discard timer for low importance is configured, the PSI base SDU discard is activated, and the PDCP SDU is delivered from the upper layer belongs to the low importance PDU set, start the discard timer for low importance associated with the PDCP SDU.

9. The terminal of claim 8, wherein the at least one processor is further configured to:
identify that the discard timer for low importance is expired for the PDCP SDU,
identify whether a PDU set discard is configured, and
discard at least one PDCP SDU belongs to a PDU set, in case that the PDU set discard is configured.

10. The terminal of claim 9, wherein one or more PDCP SDUs subsequently received from the upper layer are discarded, in case that the one or more PDCP SDUs belongs to the PDU set.

11. The terminal of claim 8, wherein the at least one processor is further configured to:
receive, via the transceiver, a medium access control (MAC) control element (CE) indicating an activation or a deactivation of the PSI based SDU discard for at least one data radio bearer (DRB),
wherein the PSI based SDU discard is activated, in case that the received MAC CE indicates the activation for the PSI based SDU discard.

12. The terminal of claim 11, wherein the PSI based SDU discard is de-activated, in case that the received MAC CE indicates the deactivation for the PSI based SDU discard.

13. A base station in a wireless communication system, the method comprising:
a transceiver; and
at least one processor is configured to:
transmit, to a terminal via the transceiver, a control message including information on a discard timer for low importance, and
transmit, to the terminal via the transceiver, a medium access control (MAC) control element (CE) indicating an activation or a deactivation of the PSI based SDU discard for at least one data radio bearer (DRB),
wherein, in case that the discard timer for low importance is configured, the PSI base SDU discard is activated, and a PDCP SDU is identified to belongs to a low importance PDU set, by the terminal, the discard timer for low importance is started associated with the PDCP SDU.

14. The base station of claim 13,
wherein the control message further includes information on a PDU set discard, and
wherein at least one PDCP SDU belongs to a PDU set is discarded, by the terminal, based on the information on the PDU set discard.

15. The base station of claim 13,
wherein the PSI based SDU discard is activated by the terminal, in case that the MAC CE indicates the activation for the PSI based SDU discard, and
wherein the PSI based SDU discard is deactivated by the terminal, in case that the MAC CE indicates the deactivation for the PSI based SDU discard.
